(19) United States
(12) Patent Application Publication
(10) Pub. No.: US 2010/0097693 A1
(43) Pub. Date: Apr. 22, 2010

(54) Confocal microscope

(76) Inventor: Kazunori Koga, Zama-shi (JP)

Correspondence Address: JORDAN AND HAMBURG LLP, 122 EAST 42ND STREET, SUITE 4000, NEW YORK, NY, 10168, US

(21) Appl. No.: 12/288,060

(22) Filed: Oct. 16, 2008

(51) Int. Cl. G02B 21/06

(52) U.S. Cl. 359/385

(57) ABSTRACT

A confocal microscope that can reduce the measurement time is provided. Linear bright lines are extracted from the light of a light source. White light emitted from the linear bright lines is chromatically dispersed into continuous wavelength components by a chromatic aberration lens, which then irradiate a sample on a stage via an objective lens. The chromatically dispersed linear bright lines are continuously imaged for each wavelength on an optical axis in the height direction, and light having one wavelength is focused on one certain point on the surface of the sample. The reflected light of light having wavelengths focused on a surface of the sample is collected by the chromatic aberration lens via the objective lens and then focused on a slit. The light passed through the slit is separated by a spectroscopic device and imaged on a two-dimensional array photodetector.

### BACKGROUND OF THE INVENTION

1. Field of the Invention

The present invention relates to a confocal microscope that measures the minute height and surface roughness of an object to be measured.

2. Description of the Related Art

Conventionally, a microscope that grasps the surface shape of an object to be measured, using laser light, is known (for example, Japanese Patent Laid-Open No. 8-210819).

In this microscope, a confocal optical system is configured such that laser light is collected on a sample by an objective lens and the reflected light is collected on a light receiving element, and the height position of the sample surface is obtained by relatively displacing the objective lens and the sample in the Z direction and measuring a position in the Z direction at which the amount of received light is maximum.

However, in such a conventional microscope, for obtaining the height of the sample surface, the height of the sample is measured by repeating the operation of displacing the relative distance between the sample and the objective lens in the Z direction by a constant amount, storing the amount of received light at the time, then, displacing the relative distance by the constant amount again, and comparing the amount of received light at the time with the amount of received light at the previous Z position, to obtain a Z position at which the amount of received light is maximum.

In this way, it is necessary to obtain data while displacing the relative distance between the sample and the objective lens in the Z axis direction, so that there is a disadvantage that the measurement is time consuming.

Also, in order to increase the measurement precision in the Z direction, it is necessary to narrow the spacing in the Z direction, when repeatedly obtaining data, to increase the resolution. In this case, the number of times of obtaining data is increased, so that there is a disadvantage that more measurement time is required.

The present invention is made in view of such conventional problems and aims to provide a confocal microscope that can reduce the measurement time.

### SUMMARY OF THE INVENTION

In order to solve the problems, the confocal microscope of the present invention comprises a white light source; means for obtaining linear bright lines from light emitted from the white light source; means for chromatically dispersing light of the linear bright lines into continuous wavelength components by a chromatic aberration lens, continuously imaging the linear bright line for each wavelength on a sample on an optical axis in a depth direction by an objective lens, and imaging reflected light or transmitted light from the sample on an imaging plane by the objective lens and the chromatic aberration lens; means for separating the light passed through a slit provided in the imaging plane; and means for imaging the separated light on a two-dimensional array photodetector.

In other words, light having a predetermined wavelength is focused on one certain point on the sample surface. Light on the blue side having a short wavelength is focused nearer to the objective lens, and light on the red side having a long wavelength is focused farther.

Also, light focused on the sample is reflected or transmitted, and the reflected light or transmitted light is imaged on the slit by the objective lens and the chromatic aberration lens to obtain confocal effect, then separated by the spectroscopic means, and then imaged on the two-dimensional array photodetector.

At this time, light having the components of wavelengths other than the wavelengths of the light focused on the sample surface is also reflected by or transmitted through the sample. But since the light is not focused, the amount of the light collected at the slit by the objective lens and the chromatic aberration lens and passed through the slit is very small, so that the light can be separated from the light having the wavelength components focused. By such confocal effect, only the light focused on the sample can be detected.

For example, when the sample has unevenness, light having a blue wavelength is focused on a certain point on the sample, and light having a red wavelength is focused on another certain point, each reflected light is complemented by the objective lens and collected at the slit by the chromatic aberration lens. Then, the light having the blue wavelength and the light having the red wavelength passed through this slit are converted into parallel light by a collimator lens and enter the spectroscopic device.

Then, the light having the blue wavelength and the light having the red wavelength entering this spectroscopic device are emitted at different angles from the spectroscopic device, enter the imaging lens at different positions, and are imaged at different positions on the two-dimensional array photodetector.

In this way, the imaging position of the separated light on the two-dimensional array photodetector is correlated to the height position on the Y axis on the sample surface, so that the information of height on a one-dimensional line on the sample can be collectively obtained in real time.

As described above, in the confocal microscope of the present invention, a minute three-dimensional shape on a one-dimensional line of an object to be measured can be collectively measured in real time.

Therefore, the measurement time can be substantially reduced, compared with the conventional case where, while the relative distance between the object to be measured and the objective lens is displaced in the Z direction, the amount of received light at each Z position should be stored and compared.

### BRIEF DESCRIPTION OF THE DRAWINGS

FIG. 1 is a schematic configuration view showing the optical systems of a confocal microscope according to one embodiment of the present invention;

FIG. 2 is a schematic configuration view of a spectroscopic optical system portion according to the embodiment; and

FIG. 3 is a view of the principle of the spectroscopic optical system according to the embodiment.

### DETAILED DESCRIPTION OF THE PREFERRED EMBODIMENT

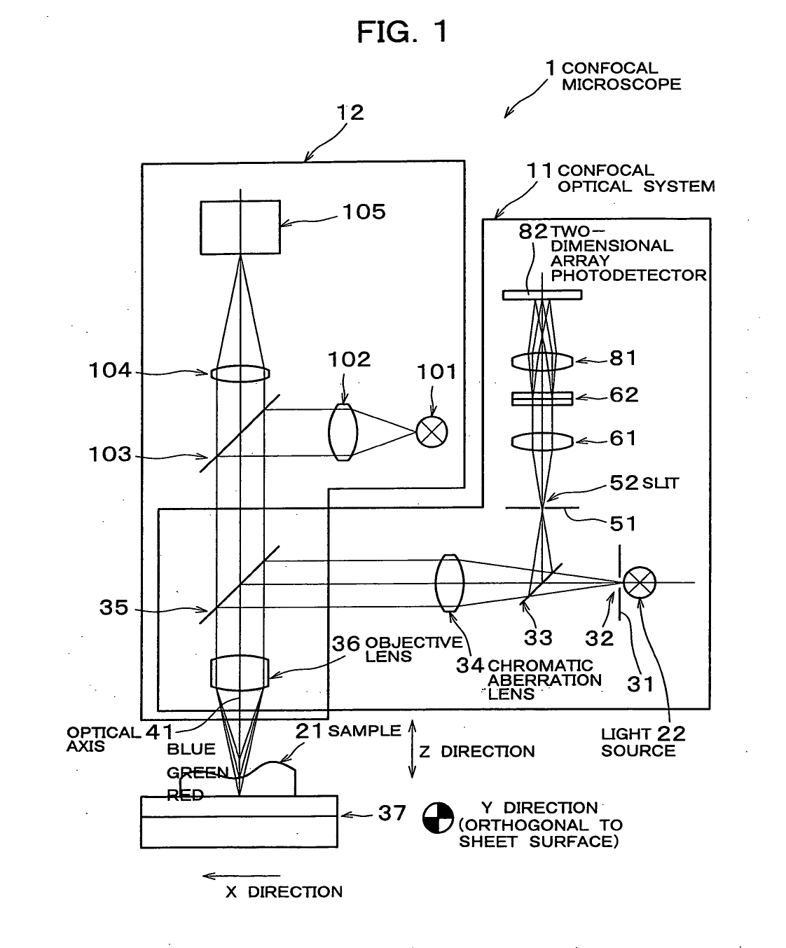

One embodiment of the present invention will be described below with reference to the drawings. FIG. 1 is a view showing a confocal microscope 1 according to this embodiment, and the confocal microscope 1 is an apparatus that measures the minute height and surface roughness of an object to be measured.

This confocal microscope 1 comprises a confocal optical system 11 and an observation optical system 12.

First, the confocal optical system 11 will be described.

This confocal optical system 11 is intended for obtaining the information of the height of the surface of a sample 21, as an object to be measured, in real time, and a light source 22 comprises a white light source, for example, a halogen lamp or a xenon lamp.

Light from this light source 22 is passed through the slit 32 of a slit plate 31, thus, linear bright lines are extracted. White light emitted from these linear bright lines is passed through a chromatic aberration lens 34 via a first half mirror 33 and chromatically dispersed into continuous wavelength components by the chromatic aberration lens 34, which are then bent by a second half mirror 35 and irradiate the sample 21 on a stage 37 via an objective lens 36. Here, it is desirable that the objective lens 36 is corrected so that the chromatic aberration is negligible.

Thus, the chromatically dispersed linear bright lines are continuously imaged for each wavelength on an optical axis 41 in the height direction by the objective lens 36, and light having one wavelength is focused on one certain point on the surface of the sample 21. Then, light having wavelengths focused on the surface of this sample 21 is reflected and travels to the objective lens 36 again.

The light passed through this objective lens 36 is bent by the second half mirror 35, collected by the chromatic aberration lens 34, then bent by the first half mirror 33, and focused on a slit 52 provided in an imaging plane 51.

At this time, light having wavelengths not focused on the sample 21 is also reflected by the surface of the sample 21, passed through the objective lens 36, and travels to the slit 52 of the imaging plane 51. But the light cannot be collected at this slit 52. Therefore, a large portion of the light cannot be passed through the slit 52, and only a very slight amount of the light can be passed through the slit 52, so that separation from the light having the wavelength components focused on the sample 21 is possible.

Then, the light passed through this slit 52 is converted into parallel light by a collimator lens 61 and then enters a spectroscopic device 62.

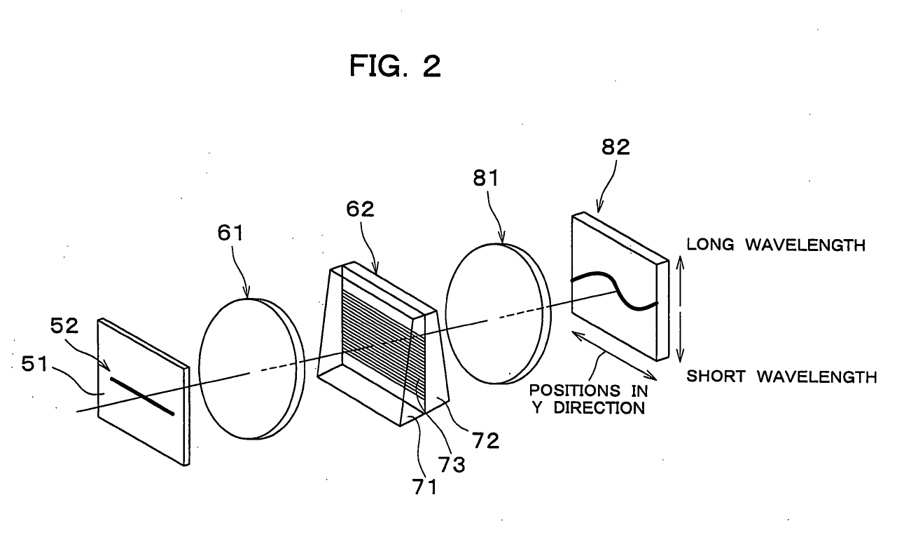

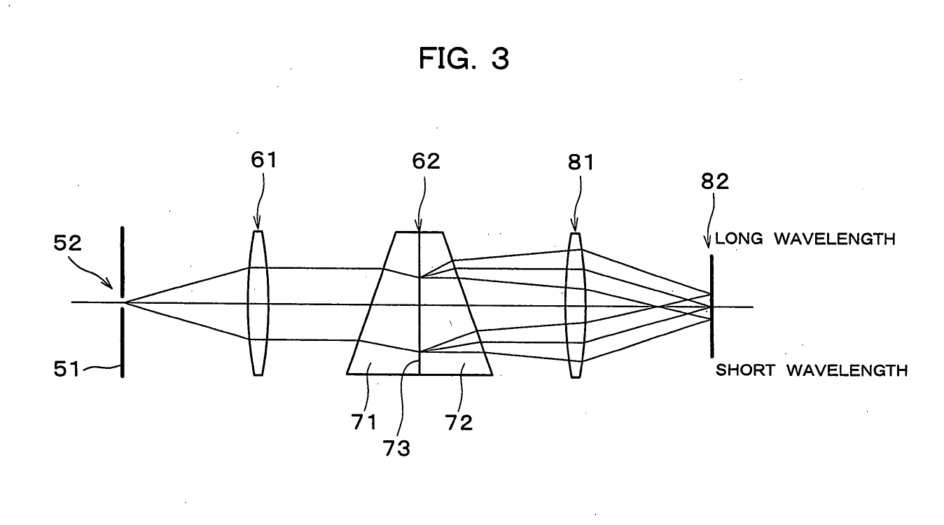

An example employing a prism-grating-prism as this spectroscopic device 62 is shown in FIG. 2 and FIG. 3.

This prism-grating-prism has a structure in which a grating 73 is sandwiched between two prisms 71 and 72. Incident light is separated by the grating 73. Light having a certain set wavelength travels straight, and light having a shorter or longer wavelength is emitted at an angle with respect to the incident light. A prism or a grating may be used alone for this spectroscopic device 62.

The light separated by such a spectroscopic device 62 is imaged on a two-dimensional array photodetector 82 by an imaging lens 81.

A CCD area image pickup device or a CMOS area image pickup device can be used as this two-dimensional array photodetector 82. As shown in FIG. 2, the light passed through the slit 52 is imaged like a strip on the two-dimensional array photodetector 82, and the shape of the strip is correlated to the height shape of the sample 21 in the range of the linear bright lines imaged on the sample 21.

Next, the observation optical system 12 will be described using FIG. 1.

Light from the light source 101 of this observation optical system 12 is passed through a collimator lens 102, bent by a third half mirror 103, passed through the second half mirror 35, and then illuminates the sample 21 via the objective lens 36. The image of the illuminated sample 21 is imaged on an image pickup camera 105 via the objective lens 36 and a tube lens 104, so that the sample 21 can be observed using the image pickup camera 105.

In this embodiment according to the above-described configuration, the light that is chromatically dispersed into wavelength components by the chromatic aberration lens 34 is imaged at a different position in the depth direction for each wavelength by the objective lens 36. At this time, light on the blue side having a short wavelength is focused nearer to the objective lens 36, and light on the red side having a long wavelength is focused farther.

When the surface of the sample 21 has unevenness, for example, light having a blue wavelength is focused on a certain point on the sample 21, and light having a red wavelength is focused on another certain point, each reflected light is complemented by the objective lens 36 and collected at the slit 52 of the imaging plane 51 by the chromatic aberration lens 34. Then, the light having the blue wavelength and the light having the red wavelength passed through this slit 52 are converted into parallel light by the collimator lens 61, then emitted at different angles by the spectroscopic device 62, and imaged at different positions on the two-dimensional array photodetector 82 via the imaging lens 81.

At this time, the imaging position of the separated light on the two-dimensional array photodetector 82 is correlated to the height position on the Y axis on the surface of the sample 21. Therefore, the information of the height of the surface of the sample 21 can be obtained from the imaging position on the two-dimensional array photodetector 82 in real time.

In this way, a minute three-dimensional shape on a one-dimensional line of the sample 21 can be collectively measured in real time, therefore, the measurement time can be substantially reduced, compared with the conventional case where, while the relative distance between the object to be measured and the objective lens is displaced in the Z direction, the amount of received light at each Z position should be stored and compared.

Also, in this embodiment, the portion on which the sample 21 is placed comprises the stage 37. Therefore, by performing measurement while operating this stage 37 to move the sample 21 in the direction crossing the linear bright lines, its measurement range can be extended in the plane direction.

Further, it is also possible to change the resolution by replacing the objective lens 36 to change the magnification.

While the case where the information of the height of the surface of the sample 21 is obtained using reflected light reflected from the sample 21 has been described in this embodiment, the present invention is not limited to this, and the information of height may be obtained by transmitted light transmitted through the sample 21.

1. A confocal microscope comprising:
a white light source;
a generator of linear bright lines produced from light emitted from the white light source;
a chromatic disperser of light of the linear bright lines which disperses the light into continuous wavelength components by a chromatic aberration lens, continuously imaging a linear bright line for each wavelength on a sample on an optical axis in a depth direction by an objective lens, and imaging reflected light or transmitted light from the sample on an imaging plane by the objective lens and the chromatic aberration lens;
a separator for separating the light passed through a slit provided in the imaging plane; and
an imager for imaging the separated light on a two-dimensional array photodetector.
